(19) United States
(12) Patent Application Publication
(10) Pub. No.: US 2012/0061867 A1
(43) Pub. Date: Mar. 15, 2012

(54) POLYMER PELLETS CONTAINING SUPERCRITICAL FLUID AND METHODS OF MAKING AND USING

(75) Inventors: Eugene P. Dougherty, JR., Camden-Wyoming, DE (US); Lih-Sheng Turng, Madison, WI (US); Chris Lacey, Cambridge, WI (US); Jungjoo Lee, Madison, WI (US); Patrick J. Gorton, Clifton Park, NY (US)

(73) Assignee: PLAYTEX PRODUCTS LLC, Shelton, CT (US)

(21) Appl. No.: 12/879,506

(22) Filed: Sep. 10, 2010

(51) Int. Cl. B29B 9/12; C08J 9/06; C08J 9/00

(52) U.S. Cl. 264/13; 521/143; 521/91; 521/95; 521/97

(57) ABSTRACT

A process for the manufacture of a plastic part, the process comprising providing a polymer, heating the polymer, introducing a gas or supercritical fluid into the polymer, mixing the polymer and the gas to produce a first melt, extruding the first melt, pelletizing the extruded first melt to form pellets, transforming the pellets into a second melt, and molding the second melt to form the plastic part. In pelletizing the first melt, individual cells of gas are included in the resulting pellets. Before the cells can nucleate, the polymer is solidified to keep the gas contained therein. After the polymer is pelletized, the pellets are considered to be unfoamed. In molding the second melt to form the plastic part, nucleation of the cells is initiated through favorable process conditions and/or additional cell nucleating agents, thereby resulting in the second melt being foamed.

### TECHNICAL FIELD

The present invention relates generally to plastic consumer and personal care items and, more particularly, to methods and materials for the manufacture of microcellular plastic foam for use in consumer and personal care items and packaging.

### BACKGROUND OF THE INVENTION

Many personal and consumer items and packages are made of plastic. One type of plastic used is thermoplastic which, through physical transformation, melts and flows when heated and re-solidifies on cooling. This process is repeatable. Another plastic type is thermosetting plastic, which reacts and crosslinks through chemical reaction and sets to form a solid. Both types are produced using one or more polymers that exhibit characteristic chemical properties. Various additives (colorants, and the like) can also be incorporated into the plastics.

Methods for processing either type of plastic, especially thermoplastics, to make personal and consumer items and packaging typically utilize one or more polymers and employ techniques such as injection molding, blow molding, extrusion, thermoforming processes, and the like. These methods are typically batch processes. Also, microcellular techniques are employed to disperse gases in the polymer, thereby resulting in the polymer being “foamed.” Using one or more of the foregoing techniques, the “foamed” polymer comprises a substantial amount of gas that, when heated and processed, is incorporated into the plastic item or packaging in the form of bubbles or voids. This type of foaming process is different from other processes that employ gas to displace hot melt and hollow out a certain portion of the final parts. For example, gas-assisted injection molding processes exist in which a gas (such as air) is introduced into the polymer as the polymer is heated to a high temperature. By introducing the gas into the heated polymer, the polymer is displaced and the volume thereof is increased. Both types of processes allow the plastic item produced to have a reduced amount of polymer, lower weight, and lower cost.

While such techniques have been widely used, there are still drawbacks associated with each of the techniques as well as drawbacks with regard to the products made by such techniques. In particular, gas-assisted molding processes are limited mainly to thick-walled parts or parts that allow built-in thick-walled sections as gas channels. More specifically, the capabilities of gas-assisted molding processes and manufacturing tolerances obtainable therewith are generally insufficient for making thin-walled parts containing hollowed-out volumes (voids). Often times, parts used in personal and consumer care items have thin-walled geometries. For example, petals used on tampon applicators are generally very thin, and thicknesses less than or about 0.015 inches are preferred in order to allow tampon pledgets to eject with minimal force. Hollowing out tiny channels in these thin-walled petals is very difficult as there is minimal control of the size of the voids. Hence, even with optimized processing, there are problems with attaining good part quality, reproducible part dimensions, minimal part warpage, and shrinkage.

One drawback to products and packaging produced using the foregoing techniques or microcellular injection molding techniques that employ supercritical fluids as physical blowing agents is the occurrence of undesirable surface features in the products and packaging. Such undesirable surface features typically occur as swirling patterns or a gritty texture and are the result of rapid cell nucleation and subsequent cell collapsing and stretching on interfaces defined by the plastic and the mold. In microcellular injection molding, cells formed by the emerging gases dispersed in the polymers nucleate at a rapid rate and those cells nucleating and expanding at the advancing melt fronts will subsequently be pushed toward the plastic-mold interface through “fountain-flow” behavior. Those cells will be compressed and stretched by the incoming plastic melt, thereby forming the swirling patterns and silver streaks typical of foamed parts. Also, in instances in which the dispersed gas is a supercritical fluid, excessively high concentrations thereof in the polymer contribute to the formation of swirling patterns. The swirling patterns or gritty texture cause parts to be produced that have poor aesthetics and/or are non-uniform in color.

### SUMMARY OF THE INVENTION

The present invention is directed to the manufacture and use of pellets loaded with supercritical fluid (hereinafter “SCF”); i.e., pellets that contain cells of SCF but are considered largely “unfoamed” until a subsequent process initiates cell nucleation, thereby “foaming” the pellets. Such pellets can be used to make light-weight, high-quality, plastic parts such as consumer and personal care items and packaging. In one aspect, the present invention resides in a process for the manufacture of a plastic part, the process comprising providing a polymer, heating the polymer, introducing a gas or supercritical fluid into the polymer, mixing the polymer and the gas to produce a first melt, extruding the first melt, pelletizing the extruded first melt to form pellets, transforming the pellets into a second melt, and molding the second melt to form the plastic part. As used herein, references to “gas” or “gas-laden pellets” is meant to include supercritical fluid or supercritical fluid-laden pellets. In pelletizing the first melt, individual cells of gas are included in the resulting pellets. Before the cells can nucleate, the polymer is quickly solidified to keep the gas contained therein. After the polymer is pelletized, the resulting pellets are considered to be largely unfoamed. In molding the second melt to form the plastic part, nucleation of the cells is initiated through favorable process conditions and/or additional cell nucleating agents, thereby resulting in the second melt being foamed.

In another aspect, the present invention resides in a process for the manufacture of gas-laden polymer pellets. In such a process, a polymer is provided, and a gas is introduced thereto. The polymer with the gas therein is heated (and mixed as desired) to produce a melt, and the melt is extruded unfoamed.

In another aspect, the present invention resides in a composition for use in manufacturing a plastic part, the composition being in pellet form. Such a composition comprises a polymer and a plurality of discrete cells located in the polymer. The cells are formed by and comprise a supercritical fluid in the form of a gas. In pellet form, the composition is in an unfoamed state. Upon activation by the melting of the polymer under pressure, the cells nucleate to foam the composition.

One advantage of the present invention is that a desirable surface quality of produced parts is achieved. By using pellets pre-loaded with SCF in order to produce substantially swirl-free, injection-molded plastic parts, the complications inherent in previously used processes are avoided. In particular, the disadvantages of parts made by microcellular injection molding processes due to excessively high SCF levels—specifically the presence of blisters, gritty surface texture, and other surface defects like swirling—are avoided. In parts produced with the pellets and by the processes of the present invention, the dimensional stability of the material used in the parts is improved as compared to the material used in standard, comparable plastic processing techniques. Furthermore, because the polymers are foamed, less plastic is used, thereby imparting both environmental and cost advantages to the process. Using less plastic is especially desirable for disposable products, such as tampon applicators.

A second advantage is that, with this process, very high part weight reductions (e.g. 15-40%) can be achieved for plastic parts where surface quality is of little or no consideration. Such parts are desirable where aesthetics are generally not a factor, for example, inside door panels of automobiles.

Another advantage is that a single equipment system making the SCF-laden pellets can serve multiple plastics processing machines, and more specifically, multiple injection molding machines to produce microcellular injection molded parts. The present invention allows for the use of the extruder and a high-pressure syringe pump or an analogous accurate metering system for SCF incorporation into a polymer in a continuous process to make quality parts that are comparable or superior to those produced using known processes.

Another advantage is that the processes of the present invention utilize equipment that is less complex than the equipment of conventional processes for injection molding of foamed components. In particular, the gas-laden but unfoamed pellets can be injection molded in conventional injection molding equipment, using only minor changes to processes that may have initially been developed for 100% solid pellets. In essence, this invention provides a simpler and more cost-effective foaming technology. Additionally, a single extruder can be used to supply pellets for multiple injection molding machines.

### BRIEF DESCRIPTION OF THE DRAWINGS

FIG. 1 is a schematic representation of an apparatus for carrying out a microcellular injection molding process of the prior art.

FIG. 2 is a schematic representation of a process, of the present invention, for producing microcellular injection molded parts using pellets, of the present invention.

FIG. 3 is a schematic representation of another gas-laden polymer extrusion process, of the present invention.

FIG. 4 is a perspective view of several strands of gas-laden polymer exiting an extruder.

FIG. 5 is a perspective view of several strands of gas-laden polymer exiting the extruder of FIG. 4 and then being cooled in a water bath.

FIG. 6 is a perspective view of several strands of gas-laden polymer in the cooling water bath leading to the pelletizer.

FIG. 7 is a perspective view of an injection molded part made using the gas-laden extrusion process, of the present invention.

FIG. 8 shows a scanning electron micrograph of the fractured cross section surface of an injection molded part made according to this invention.

### DETAILED DESCRIPTION

In the embodiments of the present invention as disclosed herein, processes of making compositions of polymers in pellet form employ extruders or similar devices. The polymer pellets (hereinafter “pellets”) produced are “unfoamed;” i.e., a polymer is pre-loaded with a supercritical fluid (hereinafter “SCF”) either dissolved or disposed in discrete cells in the polymer and activation of the cells to provide nucleation has not yet occurred or has not yet completed thereby rendering the pellets “ready to be foamed.” The actual foaming of the pellets occurs in an injection molding machine or other equipment. The parts produced from such injection molding machines or other equipment are light-weight plastic parts that can be used directly or can be assembled or otherwise used in the manufacture of such things as consumer and personal care items and associated packaging. Such parts are considered to be “foamed.” The light-weight plastic parts produced are particularly applicable for use in razors, infant care products, feminine hygiene products such as tampon applicators, and the like. The present invention is not so limited, however, as light-weight plastic parts can be produced that are applicable with regard to packaging for other products, battery manufacturing, light products, and the like.

In the processes disclosed herein, the use of longer extrusion dies together with higher pressures (as compared to extrusion dies and pressures of prior art processes) is leveraged to add the SCF to a thermoplastic or thermosetting polymer while simultaneously suppressing the nucleation of cells in the polymer. In this manner, while the SCF is added to an extruder, the material in the extruder is not foamed until the individual cells of SCF nucleate with each other, which occurs subsequently during injection molding or other applicable polymer processing methods. Thus, the processes described herein include multiple steps, namely, a first step comprising an extrusion compounding step to produce pellets laden with SCF and a second step comprising an injection molding step that produces the foamed parts using the pellets, thereby resulting in a light-weight foamed part, for example, a lower-cost tampon applicator barrel.

In an effort to reduce the swirl marks on the surfaces of microcellular injection molded parts and to reduce the gritty surface texture that can result from an excessively high concentration of supercritical fluids (or gases) that is typical of prior art techniques, the processes disclosed herein offer an option to incorporate a desirable amount of SCF into the polymer and the polymer/SCF such that the polymer melt is pelletized to produce injection molded parts that exhibit smooth, shiny, and substantially swirl-free surfaces.

The polymers that can be used in the processes of the present invention may be either thermoplastic or thermosetting in nature. Thermoplastic polymers are preferred due to their ability to be repeatedly heated, melted, solidified, and then re-melted, which allows parts and devices into which they are incorporated to be recycled.

One thermoplastic polymer that can be used in this process is low-density polyethylene (LDPE) at a concentration of at least about 70% and preferably at a concentration of at least about 80%. The present invention is not limited in this regard, however, as other polymers could be used. When used in conjunction with plastic parts for use in personal and consumer items, LDPE exhibits desirably low coefficient of friction values. Other materials that could be used include, but are not limited to, polyamides, polypropylene, other polyolefins, blends of polyolefins and other thermoplastics, polycarbonate, polystyrene, rubber, polylactides, polyalkanoates, co- and ter-polymers comprised of the above mentioned polymer types, and thermoplastic starch-based blends. Polylactides, polyalkanoates, and thermoplastic starch-based blends are renewable (sustainable) and exhibit minimal environmental impact on waste streams. Combinations of the foregoing materials are also within the scope of the present invention. The foregoing materials (and combinations of materials) can also be used in conjunction with fillers such as glass, carbon fiber, lubricants, carbon nanotubes, colorants, and the like.

One SCF that can be used is the atmospheric gas nitrogen. Nitrogen is considered to be relatively inert and provides good solubility and reasonably high diffusivity in most polymers. Also, nitrogen attains supercritical properties at reasonably low pressures and temperatures. For example, the critical temperature for nitrogen is 126.2 degrees K, and the critical pressure thereof is 3.39 megapascals (MPa). Furthermore, nitrogen is currently low in cost and can be obtained with considerable ease. In one exemplary process of the present invention, the loading of nitrogen as the SCF is about 0.04 weight percent (wt. %) to about 1 wt. %, with 0.05 wt. % to about 0.45 wt. % being preferred, and with 0.1 wt. % to about 0.35 wt. % being most preferred. Other supercritical fluids that could be used in this process include, but are not limited to, carbon dioxide, blends of nitrogen and carbon dioxide, and the like.

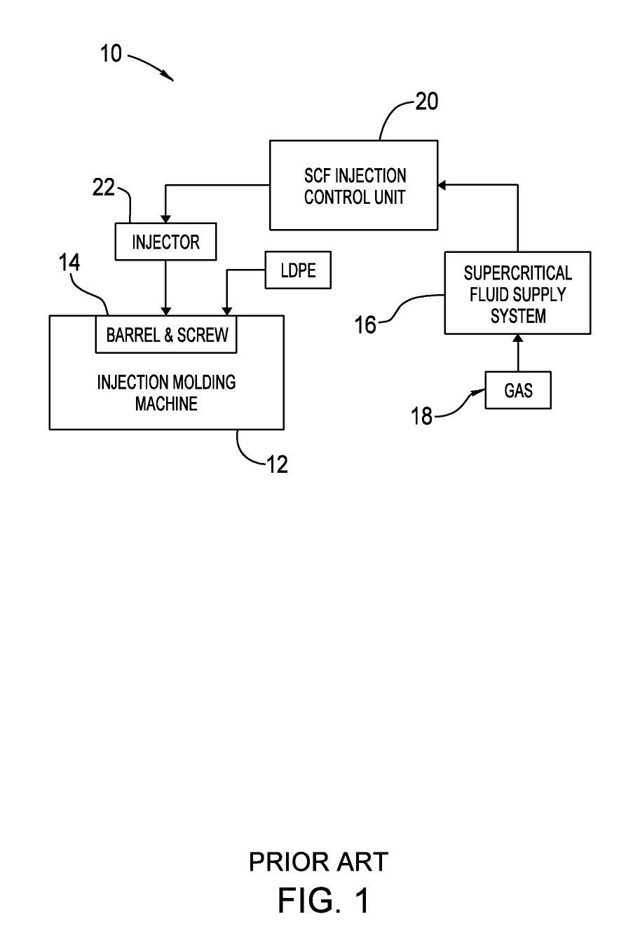

Referring to FIG. 1, an apparatus for carrying out a known microcellular injection molding process is schematically shown and designated by the reference number 10 and is hereinafter referred to as “apparatus 10.” The apparatus 10 comprises an injection molding machine 12 and a conveying section 14 in operable communication therewith. The conveying section 14 includes a barrel and screw into which polymer (e.g., in pellet form) is introduced. The apparatus 10 also comprises an SCF supply system 16, a gas supply 18, an SCF injection control unit or backpressure regulator 20 used to regulate the supply of SCF, and an injector 22. The gas supply 18 comprises the SCF, which is pumped via pumps in the SCF supply system 16 to the conveying section 14. The flow of the SCF to the conveying section 14 is regulated via control valves in the SCF injection control unit or backpressure regulator 20 and dispensed to the conveying section 14 through the injector 22. In apparatus 10, the polymer is foamed as it leaves the barrel and screw of the conveying section 14 and enters into the mold(s) through the machine nozzle.

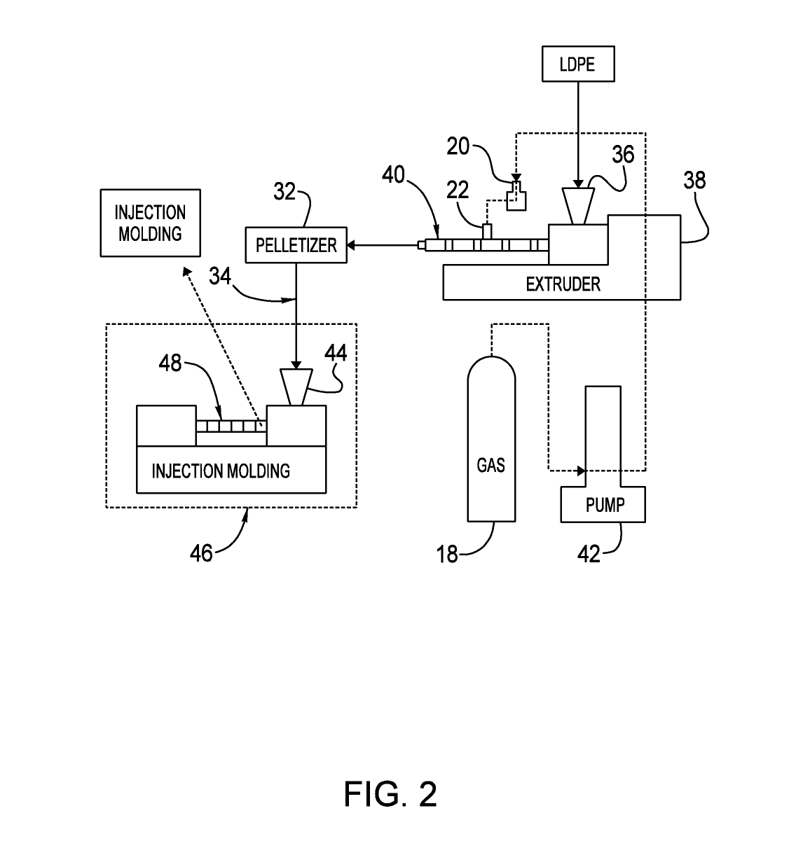

Referring now to FIG. 2, a process for producing microcellular injection molded parts using pellets of the present invention is designated generally by the reference number 30 and is hereinafter referred to as “process 30.” In a first step of the process 30, LDPE (or some other polymer) is loaded into a hopper 36 of an extruder 38 and transported through a conveying section 40 using a plasticizing screw located in a barrel. The SCF is introduced into the LDPE in the conveying section 40 from a gas supply 18 and through a syringe pump 42, a backpressure regulator 20, and an injector 22. The syringe pump 42 directly controls the amount of SCF from the gas supply 18 by controlling the gas flow rate or pressure. The backpressure regulator 20 is employed to reduce the pressure fluctuation of the SCF. The resulting LDPE with the SCF introduced therein provides a SCF-laden first melt. In introducing the SCF from the gas supply 18 into the LDPE and transporting the resulting first melt through the conveying section 40, cells of SCF are formed in the LDPE.

Controlling the rate of flow or the pressure of the SCF from the gas supply 18 precisely can be achieved using the syringe pump 42 together with the backpressure regulator 20 (or any other suitable control unit). The syringe pump 42 has two operating modes, namely, constant pressure and constant flow rate. When the SCF is CO₂, the constant pressure mode is generally used. Use of the syringe pump 42 in the constant pressure mode allows for the control of the formation of cells of SCF, which, in conjunction with the process conditions and die design, allows for the nucleation of the cells to be inhibited or suppressed. One exemplary high pressure syringe pump 42 is a metering high pressure syringe pump from Teledyne ISCO of Lincoln, Nebr. The SCF-laden LDPE is extruded into a pelletizer 32 in which pellets 34 are formed, the pellets being loaded with the SCF. At this point, the pellets 34 are considered unfoamed.

In a second step of the process 30, the pellets 34 loaded with SCF are fed to a hopper 44 of an injection molding machine 46. The pellets 34 are transported along a conveying section 48 of the injection molding machine 46 and are heated as they move through the conveying section using primarily the friction from shearing the pellets between the screw and the walls of the extruder barrel and any suitable heating means (e.g., heat from shear or heat from an electrical source) to produce a second melt. The resulting second melt (laden with the SCF) is directed into one or more molds of the injection molding machine 46 via a suitable system of runners and gates. A rapid pressure drop as the SCF-laden melt leaves the conveying section 48 and enters into the mold(s) leads to the foaming of the second melt (i.e. nucleation of the cells of SCF), thereby forming microcellular injection molded parts having about as many as 10³ to 10⁷ pores per cubic centimeter of LDPE. Due to the incorporation of the SCF into the LDPE and the production of pellets 32 that are subsequently foamed during the injection process, the resulting foamed plastics are essentially “swirl-free” and can be molded without the need for any additional equipment or modifications to standard equipment.

In another embodiment of the present invention, the pellets 34 are used in other polymer processes, such as blow molding to make foamed bottles or in conjunction with a second extrusion process to make simple parts such as foamed, extruded sheet or pipe.

Embodiments of the present invention utilizing injection molding processes are especially useful in the production of lightweight plastic tampon applicators. Barrels for such lightweight plastic tampon applicators can be produced by first extruding the pellets 34 followed by injection molding. The resulting barrels are thereby “foamed.” Tampon applicator plungers can also be produced by first extruding the pellets 34, followed by a second extrusion to make the foamed plunger part. Furthermore, any number of useful plastic parts for durable goods, plastics packaging, bottles, toys, automotive parts, construction parts, and the like can be made inexpensively using the pellets 34 of the foregoing process or similar types of processes.

In yet another embodiment of the present invention, the pellets 34 can be in the form of a “concentrate.” That is, less than all of the plastic (e.g., LDPE) may be processed in the extruder 38 (e.g., only a portion of the total amount of plastic is supplied to the extruder) with the remainder of the plastic being added in the injection molding machine 46.

In still another embodiment of this invention, the gas or SCF for the extruded pellets can be generated using sodium azide (NaN₃). Sodium azide is a solid chemical blowing agent used in automotive air bags. Similar solid agents may also be used. Upon activation of sodium azide crystals (typically by an impacting force), nitrogen gas is liberated from the sodium and can be used as a foaming agent. A hopper or other suitable mass flow system can be used to convey the solid sodium azide to an extruder to make a ready-to-foam sodium azide/plastic mixture. This mixture would be foamed upon a subsequent processing step; e.g., when the mixture is injected into a mold to form a part. The step of extruding the sodium azide with the plastic is used to mix the materials together, whereas the step of injecting the mixture containing the sodium azide and plastic provides suitable impacting force for activating the sodium azide to liberate the nitrogen.

In yet another embodiment of this invention, materials can be added that slow down or suppress nucleation of bubbles in the extruder, and, alternatively, speed up or increase the nucleation rate of bubbles in the injection molding machine. For example, the addition of nanoclays such as montmorillonite modified with a quaternary ammonium salt (e.g., Cloisite 20A, which is available from Southern Clay Products of Gonzales, Tex.) can be added at low levels in an injection molding machine to speed up nucleation. Lubricants (e.g., erucamide or ethylene bis-stearamide) can also be added as anti-nucleating agents. Without being restricted by theory, by means of manipulating surface tension, chemical agents have been shown either to increase or decrease nucleation rates markedly and thus produce no foam in the extruder than would otherwise be produced and more bubbles more rapidly in an injection molding machine. Such materials can produce significant part weight reductions having significant savings.

### EXAMPLE 1

### Calculation of Parameters for Production of SCF-Laden Pellets

The gas flow rate for producing pre-loaded supercritical fluid pellets using a laboratory-sized extruder and an injection molding machine (an Arburg 320S) was calculated. From the calculations, it was determined that a minimum gas flow rate of 0.025 to 0.25 milliliters per minute (ml/min) would be suitable for providing nitrogen as the SCF and that a gas flow rate of 0.55 to 0.6 ml/min would be suitable for providing carbon dioxide as the SCF. These flow rate ranges would allow for the production of the desired SCF-laden pellets for the subsequent injection molding process of manufacturing foamed parts.

Some numerical estimates of various material properties, solubilities, flow rate estimates, and other operating conditions useful for the production of SCF-laden pellets are listed in Table 1 below.

TABLE 1
Gas flow rate for producing SCF-laden (pre-
SCF-loaded) pellets using extruder.*

| | Gas type | |
|---|---|---|
| Properties | Carbon dioxide | Nitrogen |
| Critical pressure (bar) | 73.9 | 34 |
| Critical temperature (° C.) | 31.1 | −147 |
| Suggested Operating Conditions, | | |
| Listing the Preferred Range and | | |
| Most Preferred Target | | |
| Operating temperature (° C.) | 0-25; 5 | −140 to +40; 25 |
| Operating pressure (bar) | 50-150; 70-100 | 35-200; 180 |
| Expected compressibility factor of | 0.1603 | 1.0167 |
| gas at target operating conditions | | |
| Expected density of gas at target | 0.162 by EES** | 0.203 by EES** |
| operating conditions (g/cm³) | | |
| Material type | PP or LDPE, | PP or LDPE, |
| | LDPE | LDPE |
| Material flow rate (g/min) | 50-250; | 50-250; |
| | 150-200 | 150-200 |
| Expected solubility of gas in | 0.040-0.06; | 0.003-0.04; |
| LDPE (@ 1 atm, 220° C.) (wt %) | 0.051 | 0.03 |
| Amount of gas for producing SCF- | 0.03-0.02; 0.09 | 0.002-0.10: |
| loaded pellets (g/min) | | 0.005-0.05 |
| Minimum gas flow rate (ml/min.) | 0.02-0.7; | 0.01-0.3; |
| | 0.55-0.6 | 0.025-0.25 |

*In this table, two sets of values or ranges are suggested: the first set of values gives a preferred value or range; the second gives a more preferred value or range.
**Engineering Equation Solver software available as a download from various sources.

### EXAMPLE 2

### Proposed Equipment and Set-Up for Production of SCF-Laden Pellets

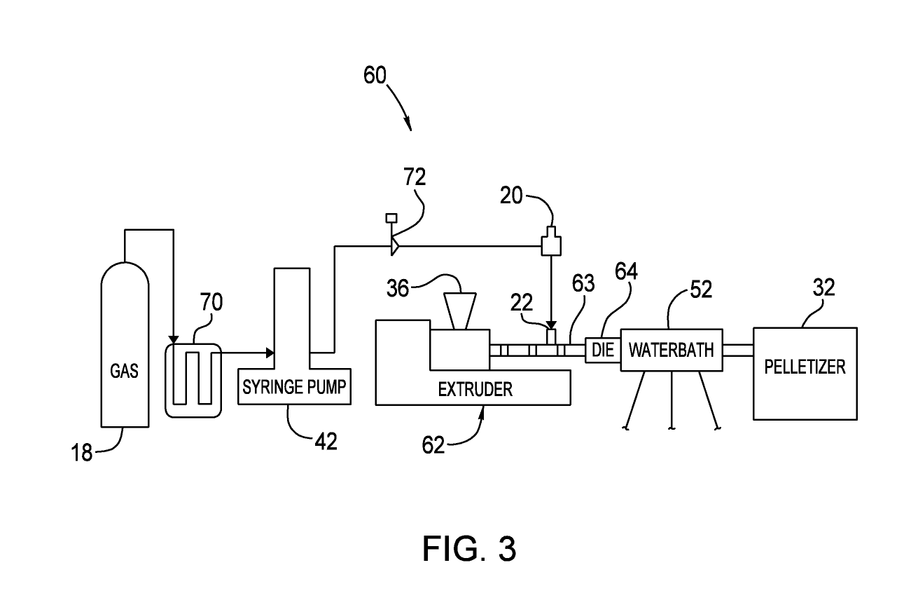

Referring now to FIG. 3, an equipment set-up for the production of SCF-laden pellets is shown generally at 60. The set-up 60 includes a single screw extruder 62 (Model No. ED-N 45-30D available from Extrudex of Painesville, Ohio) having a conveying portion 63 with a single plasticizing screw, a hopper 36 into which polymer is introduced, and an injector 22 through which the SCF is introduced; a multi-strand extrusion die 64 located to receive plasticized and SCF-laden melt from the conveying portion 63; a water bath 52 to receive extruded material from the extrusion die 64; and a pelletizer 32 (Model No. SGS 100-E available from Extrudex of Painesville, Ohio) for receiving the extruded material from the water bath 52.

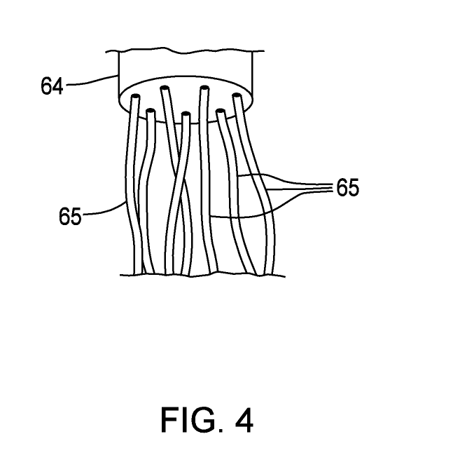

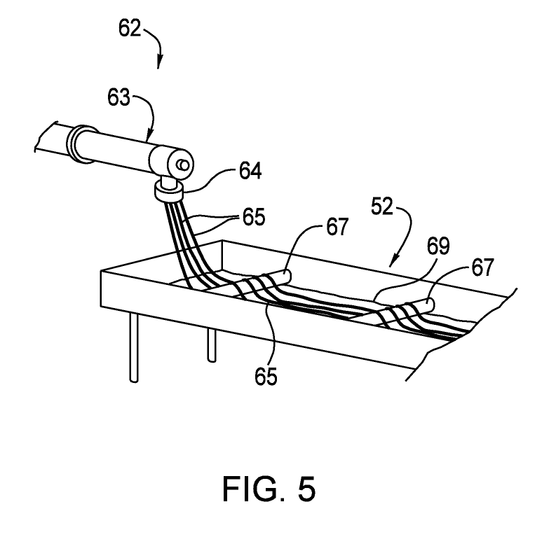

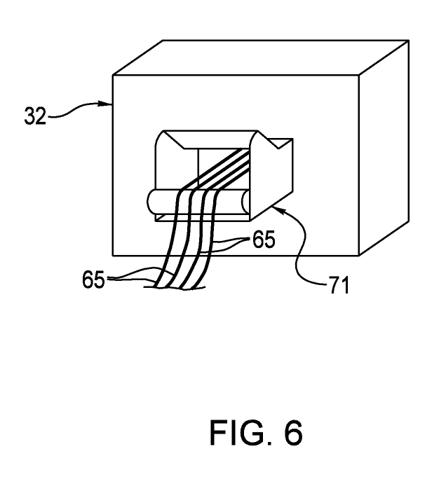

As is shown in FIGS. 4 and 5, the SCF-laden melt is received from the conveying portion 63 in strand form (strands 65) and fed to the water bath 52. The water bath 52 comprises an elongated trough having rollers 67 located along the length thereof over which the strands 65 can be laid. During operation of the set-up 60, portions of the strands 65 not laying over the rollers 67 contact the water in the water bath 52 and may extend below a waterline 69. As is shown in FIG. 6, the strands 65 are pulled over the rollers 67 and through the water bath 52 and into a chute 71 of the pelletizer 32. Once in the pelletizer 32, the strands 65 are chopped or otherwise cut into suitably sized pieces and pelletized. For water soluble polymers, cooling fans can be used in lieu of the water bath to cool down the extruded strands.

Referring back to FIG. 3, a suitable syringe pump 42 having capabilities to control pressure and flow is also proposed. The syringe pump 42 will facilitate the flow of nitrogen or carbon dioxide at the low, constant flow rate calculated. One exemplary syringe pump 42 is available as Model No. 260D from Teledyne ISCO of Lincoln, Nebr. A backpressure regulator 20 was used to control the SCF flow rate.

In instances in which the SCF is carbon dioxide, a chiller 70 is also used for control of the flow and pressure of the carbon dioxide from the gas supply 18 at supercritical temperatures to the injector 22. When the SCF is nitrogen, control of the flow and pressure thereof from the gas supply 18 to the injector 22 can be attained at or near ambient or room temperatures, so a chiller is not necessary when nitrogen is used.

A gas injector 22 configured as two cylinders, a smaller one with a tip on top of a larger diameter one, has been found to be a useful means to realize the full benefits of this invention. In this injector design, the tip has been removed, and it has a broad area, to allow more gas to penetrate through the Porcerax, which is a porous metallic alloy that allows the SCF to flow through while preventing the much more viscous polymer melt from leaking through. Thus this injector is actually a valve. The bottom of this valve connects to the syringe pump while the top connects to the barrel of the extruder. Back flow is not possible. The side surface is sealed. The material is used to allow gas to vent out.

The extruder 62 used could be any suitable extruder. Various models of extruders or extrusion compounders are commercially-available and suited for use in the present invention. Commercial extruders are available from Werner-Pfleiderer of Ramsey, N.J., as well as other companies. At least one such device is available from LTL Color Compounders of Morrisville, Pa. In the examples provided here, commonly designed screws were used, although special mixing element screws (i.e. those having reverse flights) may be preferred, in order to facilitate mixing of the SCF with the polymer.

In the proposed set-up 60 for the production of the SCF-laden pellets, seals located on the plasticizing screw of the conveying section 63 of the extruder 62 may be present to limit the escape of any gas flashing off the melt. In embodiments in which LDPE (or similar thermoplastics) is used as the polymer, however, theoretical considerations suggest that solubility of the SCF from the gas supply 18 increases with increasing melt temperature. Hence, when melting of the polymer occurs, the SCF will likely remain in the LDPE. In other words, as long as the gas content is maintained below the saturation or super saturation point, the SCF is not expected to escape from the barrel of the conveying portion 63 of the extruder 62. The screw used may have a reverse flight configuration. Irrespective of the flight configuration, in order to mix the polymer melt with the SCF, the screw is configured to achieve a homogenized polymer melt/gas system. Alternatively, a suitable static mixer could be installed between the barrel of the conveying portion 63 and the extrusion die 64.

Gas inlet or check valves 72 are also employed to prevent the polymer melt from flowing back to the syringe pump 42. A mass flow controller or porous metal flow controller such as the SCF injection control unit 20 is also desired to facilitate a uniform injection of the SCF.

The extrusion die 64 is configured such that the polymer melt/gas system will not foam before it exits the conveying portion 63 of the extruder 62. The extrusion die 64 should therefore be of sufficient length to facilitate the cooling of the melt, thus suppressing the nucleation of bubbles in the melt. Also, to prevent the foaming from taking place prematurely, the temperature can be reduced further by extruding into the water bath 52.

In the course of the operation of the equipment of the proposed set-up 60, the amount of SCF that can be added without premature foaming of the melt can be determined experimentally. Other variables that ensure process stability, determine foaming rates, assess the shelf life of the SCF-laden pellets produced, and contribute to subsequent extrusion and injection molding processes can also be determined. Dimensional stability and mechanical and surface properties of the foamed plastic parts produced can also be assessed.

### EXAMPLE 3

### Production of SCF-Laden Pellets Using LDPE and Supercritical Carbon Dioxide

The production of SCF-laden pellets was carried out under the following operating conditions:
Material: LDPE (KN226, Chevron-Phillips)
CO₂ liquid/gas cylinder with siphon (60 bar with a full cylinder)
Chiller with water set at 3 degrees C.
The syringe is covered by insulation to prevent heat loss
Commonly designed extruder screw (i.e. no reverse flight screws or special mixing elements)
Gas refill rate: 7 ml/min.
Screw speed: 30 rpm

Two modes were used to run the experiments, namely constant flow and constant pressure. In the constant flow mode, the flow rate ranged from 0.5-10 ml/min. The pressure increased during the run to 60-70 bar, at which point the gas was pumped to the extruder irregularly. In the constant pressure mode, the pressure was adjusted from 60 up to 100 bar. When the pressure exceeded 75 bar, the material was observed to foam. At a gas pressure of 70 bar, non-foamed pellets, which contained carbon dioxide, were produced. At 70 bar, the flow rate was 2.5-3 ml/min.

### EXAMPLE 4

### Production of SCF-Laden Pellets Using LDPE and Nitrogen (Comparative)

The production of SCF-laden pellets was carried out under the following operating conditions:
Material: LDPE (KN226)
Blowing agent: nitrogen gas
No chiller
Commonly designed extruder screw
Gas refill rate: 80 ml/min.
Gas refill pressure: 170 bar
Screw speed: 30 rpm

Again, two modes were used to run the experiments (constant flow and constant pressure). In the constant flow mode, the flow rate ranged from 0.5-20 ml/min. When the gas flow rate was low (less than about 10 ml/min.), the gas dosage could only be controlled by an outlet valve regardless of gas flow rate. In the constant pressure mode, the pressure was increased from 70 to 180 bar. In this Example, the constant pressure mode was not suitable, since the gas filling pressure was too high. With a pressure setting of 70 to 160 bar, the actual flow rate was less than zero, since it was below the operational threshold.

### EXAMPLE 5

### Additional LDPE and CO₂ Experiments (Comparative)

SCF-laden pellets were produced under the following operating conditions:
Material: LDPE (KN226)
Blowing agent: carbon dioxide
Chilled water temperature: 3 degrees C.
Pressure: 60-62 bar
Rate: 7 ml/min.
Constant pressure mode, set at pressures ranging from 70 to 85 bar
Screw: commonly designed extruder screw
Screw speed: 25 and 30 rpm

Upon operating an extruder and a die with material under the above conditions, strands of the LDPE were obtained from the die, cooled in the water bath, and pelletized. As is shown in FIG. 5, strands of the LDPE were obtained from the extrusion die 64 and run through the water bath 52. The resulting strands were then cut and pelletized in the pelletizer 32. Table 2 (below) provides a summary of the operating conditions and results. Pellets from these experiments were injection molded to form test specimens. Under these conditions, the injection molded samples did not contain bubbles. On the other hand, when these pellets were exposed to the atmosphere through purging, the cells nucleated slowly to form bubbles. It was concluded that, due to the slow cell nucleation rate, the cells did not have time to form bubbles during injection.

TABLE 2
Operating Conditions and Results for Experiments of Example 5.

| Pressure | Flow rate | Screw | Storage period for | Gas inside |
|---|---|---|---|---|
| (bar) | (ml/min.) | speed (rpm) | pellets prior to IM (hr) | pellet |
| 70 | 2.5-3.0 | 30 | 72 | Yes, but |
| | (0.17 wt %) | | | very little |
| 75 | 3.0-3.5 | 25 | 0.5 | Yes |
| | (0.26 wt %) | | | |
| 80 | 3.5-3.8 | 25 | 0.5 | Yes |
| | (0.31 wt %) | | | |
| 85 | 3.8-4.2 | 30 | 0.5 | Yes |
| | (0.30 wt %) | | | |

### EXAMPLE 6

### LDPE Plus Color Concentrate and Polypropylene with Carbon Dioxide

The following operating conditions were used in Example 6:
Materials: LDPE (KN226), including 5 weight percent of a green solid color concentrate
Blowing agent: Carbon dioxide
Chiller Temperature: 3 degrees C.
Pressure: 46-48 bar
Rate: 20 ml/min
Constant pressure mode: 90-150 bar
commonly designed screw
Screw speed: 20 rpm

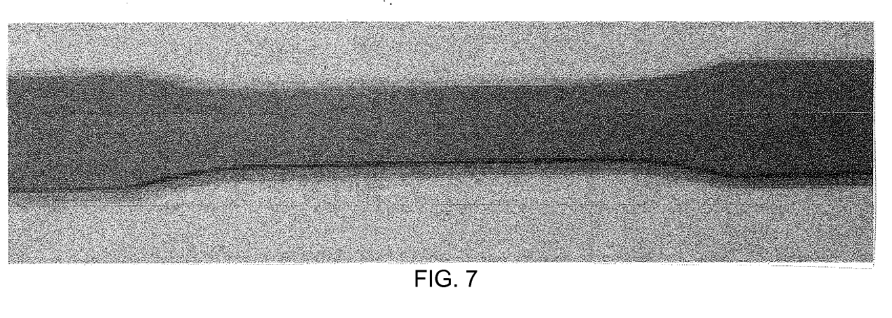

Table 3 provides a summary of the operating conditions and results for Example 6. In experiment 6c, samples molded from the extruded, ready-to-foam pellets exhibited weight reductions of about 6% in weight. Swirl marks were observed on their surfaces. Samples molded after shelf life testing was commenced (i.e. 6c1) exhibited more desirable surface quality than those of 6c because the supersaturation level was lower. FIG. 7 shows an injection molded part made from pellets from experiment 6c1. This part exhibited a part weight reduction of 4% and exhibited a highly desirable surface quality. The gas pressure used in experiment 6b (100 bar) is not sufficiently high enough for injection molding. At such a pressure, cell nucleation rates were reduced, because the colorants blocked the flux of gas through polymer matrix, i.e. the colorants acted as anti-nucleating agents.

In the shelf life study described in Table 3, extruded polymer that was pelletized was subjected to ordinary ambient atmospheric conditions. As Table 3 and FIG. 7 show, the part quality depends upon how long the pellets have been exposed. Subjecting the pellets to a CO₂-rich atmosphere would be one possible way to maintain the gas concentration in the pellets at the proper level. This would represent yet another embodiment of this invention.

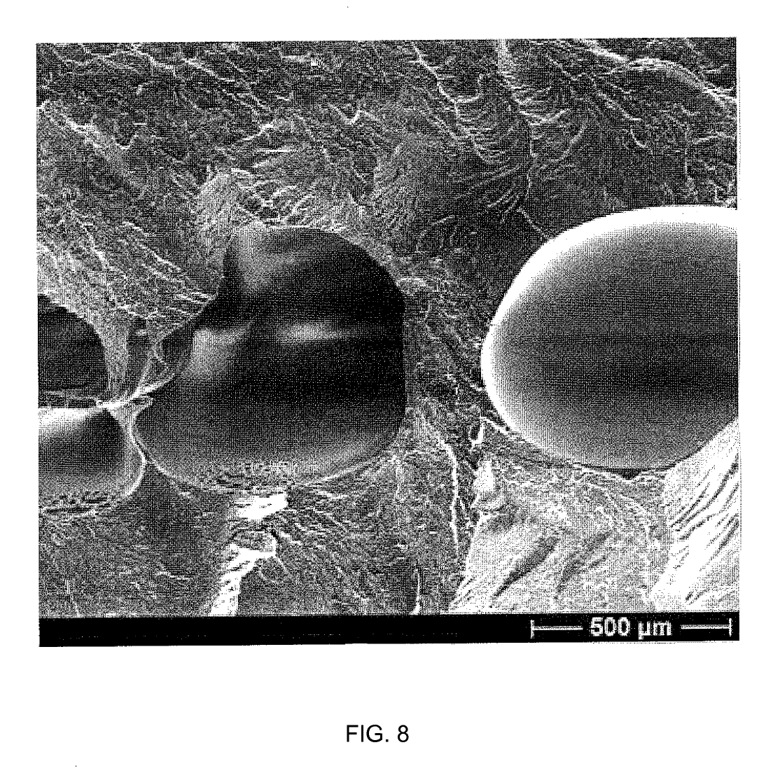

Samples from experiments 6a, 6a1, 6a2, 6c, and 6c1 were fractured and observed by means of scanning electron microscopy. The parts molded from samples produced in experiment 6a2 did not contain any bubbles. Other samples did exhibit bubbles, with an average diameter of about 500 μm. FIG. 8 provides an SEM for the part produced in experiment 6c. The slow cell nucleation rate caused some bubbles to be nucleated slowly; but they did not fully grow out.

TABLE 3
Operating Conditions and Results from Experiments of Example 6.

| | | | | Screw | Storage | |
|---|---|---|---|---|---|---|
| | | Pressure | Flow rate | speed | period | Gas inside |
| Exp. | Colorant | (bar) | (ml/min.) | (rpm) | (hr) | pellet |
| 6a | Yes | 115 | 3.0-3.4 | 20 | 0.5 | Yes, a lot |
| 6a1 | Shelf life study | | | | 24 | Yes, a lot |
| 6a2 | | | | | 8 days | Yes, but not |
| | | | | | | enough for |
| | | | | | | molding |
| 6b | Yes | 100 | 2.2-2.6 | 20 | 0.5 | Yes, but little |
| 6c | Yes | 125 | 3.7-4.2 | 20 | 0.5 | Yes, a lot |
| 6c1 | Shelf life study | | | | 4 days | Yes |
| 6c2 | | | | | 7 days | Yes, but not |
| | | | | | | enough for |
| | | | | | | molding |
| 6d | Yes | 135 | 3.7-4.0 | 20 | 0.5 | Yes, a lot |
| 6e | Yes | 150 | 4.8-5.2 | 20 | 0.5 | Yes, a lot |

### EXAMPLE 7

### Polypropylene with Carbon Dioxide

This example is similar to that of the experiments done in Example 6, except that an injection-molded grade of Polypropylene (PP) (Nova SR256M) was used. No colorant was used. Table 4 summarizes the operating conditions and results for Example 7.

The extruded polymeric strands exhibited large bubbles, which were actually visible to the naked eye. During the extrusion, carbon dioxide was captured in the polymer matrix after the polymer was cooled due to the slow cell nucleation rate. Samples molded with this material did not exhibit bubbles. Carbon dioxide exhibited a higher solubility in PP than it did in LDPE. Higher gas pressures, i.e. higher flow rates would be required for PP (as compared to those used for LDPE).

TABLE 4
Operating Conditions and Results for Example 7.

| | | | | Screw | Storage | Gas |
|---|---|---|---|---|---|---|
| | | Pressure | Flow rate | speed | period | inside |
| Exp. | Colorant | (bar) | (ml/min.) | (rpm) | (hr) | pellet |
| 7 | No | 90 | 2.7-2.9 | 20 | 0.5 | No |

### EXAMPLE 8

### Polypropylene with Carbon Dioxide and Nanoclay Addition During Molding

This example is similar to that of Example 7, but there are some differences. An extruder screw having mixing elements was used for the extrusion process. The polymer used was polypropylene, specifically SR256M. Supercritical carbon dioxide was added as the foaming agent. The pressure was maintained to be within a range of 60-65 bar. This process produced non-foamed pellets in the extruder. At the injection molding machine, a 3 weight percent loading of nanoclay, in particular Cloisite 20A, was added as a nucleating agent together with the extruded, not-yet-foamed pellets. The part molded was a dogbone-shaped tensile bar. The weight reduction of such molded parts was observed to be up to 15% (vs. that of conventional injection molding); and the parts exhibited reasonable surface and bulk mechanical properties. Such part weight reduction can result in significant economic savings.

The above examples exemplify the invention. They also show that, depending upon operating conditions and materials used, it is possible to get a significant amount of gas or SCF into the pellets, which may either partly or fully nucleate bubbles. Also, once the gas-laden pellets are introduced into an injection molding machine, nucleation may occur or fully complete. Importantly, in at least one example (Example 6, experiment 6c1), one can obtain both part weight reduction and an improved surface quality part by injection molding, using the process of this invention.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above description, but that the invention will include all embodiments falling within the scope of the appended claims.

What is claimed is:

1. A process for the manufacture of a plastic part, the process comprising:
providing a polymer;
heating the polymer;
introducing a gas into the polymer;
mixing the polymer and the gas to produce a first melt;
extruding the first melt;
pelletizing the extruded first melt to form pellets;
introducing the pellets into a mold and causing the pellets to melt to produce a second melt; and
molding the second melt to form the plastic part;
wherein the pellets formed in the step of pelletizing the first melt comprise cells of the gas and are unfoamed; and
wherein the molding of the second melt foams the second melt to form the plastic part.

2. The process of claim 1, wherein introducing the gas into the polymer comprises controllably supplying a supercritical fluid to the polymer.

3. The process of claim 2, wherein introducing the gas into the polymer comprises controllably supplying the supercritical gas from a gas supply and injecting the supercritical gas into the polymer.

4. The process of claim 2, wherein introducing the gas into the polymer comprises introducing the gas from a solid agent combined with the polymer.

5. The process of claim 1, wherein introducing the gas into the polymer comprises controlling the flow and pressure of the gas using a chiller.

6. The process of claim 1, wherein mixing the polymer and the gas to produce the first melt comprises transporting the polymer and the gas through a barrel of an extruder using a plasticizing screw.

7. The process of claim 1, wherein extruding the first melt comprises cooling the first melt to suppress nucleation of the cells of the gas therein, thereby maintaining the unfoamed state of the first melt by transporting the first melt along a suitable length of an extrusion die.

8. The process of claim 1, wherein molding the second melt to form the plastic part is selected from the group of injection molding techniques and blow molding techniques.

9. The process of claim 1, wherein the plastic part formed is substantially free of swirls.

10. The process of claim 1, wherein the polymer is low density polyethylene.

11. The process of claim 1, wherein the gas is one or more of nitrogen and carbon dioxide.

12. The process of claim 1, further comprising exposing the pellets to an atmosphere for a sufficient length of time to allow a desired level of the gas to be maintained in the pellets prior to carrying out the molding step.

13. The process of claim 1, wherein the plastic part is a tampon applicator, a tampon applicator barrel, a razor, a personal care product, or a consumer product.

14. The process of claim 1, further comprising adding a nucleating agent selected from the group consisting of nanoclays to the second melt to nucleate bubbles in the plastic part.

15. The process of claim 14, in which the nanoclay is montmorillonite modified with a quaternary ammonium salt.

16. The process of claim 1, further comprising adding an anti-nucleating agent to suppress foam formation.

17. The process of claim 16, wherein the anti-nucleating agent is a lubricant selected from the group consisting of erucamide and ethylene bis-stearamide.

18. A process for the manufacture of a gas-laden polymer pellet, the process comprising:
providing a polymer;
introducing a gas into the polymer;
heating the polymer and the gas to produce a melt; and
extruding the melt;
wherein the extruded melt is unfoamed.

19. The process of claim 18, wherein introducing the gas into the polymer comprises supplying a supercritical gas to the polymer.

20. The process of claim 18, wherein introducing the gas into the polymer comprises controllably injecting a supercritical gas into the polymer.

21. The process of claim 18, wherein introducing the gas into the polymer comprises controlling the flow and pressure of the gas.

22. The process of claim 18, wherein introducing the gas into the polymer comprises introducing the gas from a solid agent combined with the polymer.

23. The process of claim 18, further comprising pelletizing the extruded melt to form pellets.

24. A composition for use in manufacturing a plastic part, the composition being in pellet form and comprising:
a polymer;
a plurality of partially nucleated cells located in the polymer, the cells comprising a supercritical fluid in the form of a gas;
wherein the composition is in a substantially unfoamed state and activatable to a foamed state by a substantially complete nucleation of the cells upon melting of the polymer and application of pressure.

25. The composition of claim 24, wherein the polymer is low density polyethylene.

26. The composition of claim 24, wherein the polymer is selected from the group consisting of polyamides, polypropylene, other polyolefins, blends of polyolefins and other thermoplastics, polycarbonate, polystyrene, rubber, polylactides, polyalkanoates, co- and ter-polymers comprised of the above mentioned polymer types, thermoplastic starch-based blends, and combinations of the foregoing material.

27. The composition of claim 26, further comprising a material selected from the group consisting of fillers, colorants, nanoclays, lubricants and combinations of the foregoing materials.

28. The composition of claim 24, wherein the supercritical gas is nitrogen.

29. The composition of claim 24, wherein the supercritical gas is selected from the group consisting of nitrogen, carbon dioxide, and combinations of the foregoing materials.

30. The composition of claim 24, wherein the polymer is low density polyethylene and the supercritical gas is nitrogen.

31. The composition of claim 24, in which the partially nucleated cells in the polymer are treated with an atmosphere to adjust the level of gas or supercritical fluid and the degree of nucleation completion so as to obtain an injection molded part containing the gas or supercritical fluid.
